(19) United States
(12) Patent Application Publication
(10) Pub. No.: US 2002/0129341 A1
(43) Pub. Date: Sep. 12, 2002

(54) Selective expansion of high-level design language macros for automated design modification

(76) Inventor: Gregory Hibdon, Folsom, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/753,279

(22) Filed: Dec. 30, 2000

(51) Int. Cl. G06F 9/45

(52) U.S. Cl. 717/136

(57) ABSTRACT

A method and apparatus are described for selective expansion of HDL macros for automated design modification. According to one embodiment of the present invention, the selective expansion of HDL macros allows for insertion of scan cells for selected signals into HDL design files comprising a hardware design while making the modified file look as much as possible like the designer's original HDL file by using an “as if” approach to parsing HDL design macros, using multifaceted parser tokens, and using a three-tiered token list. In order to make the modified file look as much as possible like the designer's original HDL file all text except the required changes are preserved from the original file. To accomplish this, the parsing program used by the HDL scan insertion tool creates lists of tokens that record everything including spaces, tabs, and comments. Then to perform the modifications to the HDL, the token lists, representing “lines” from the HDL file, are modified before they are written back out as the updated scan inserted HDL file.

### FIELD OF THE INVENTION

The invention relates generally to the field of design-for-test (DFT) and scan insertion. More particularly, the invention relates to selectively expanding macros within a hardware description language (HDL) in a context sensitive manner.

### BACKGROUND OF THE INVENTION

Complex Very Large Scale Integration (VLSI) designs such as microprocessors are typically designed in HDL. A design represented in such an HDL is then translated into circuitry to be etched onto silicon. A common practice during design is to insert test points to allow more efficient testing of the device. The inserted cells can be checked during testing to verify smaller circuits within the larger design and thereby provide a more effective and efficient means of testing the device. Scan insertion is a standard design-for-test (DFT) method that enables structural test generation in such a manner.

There are various standard software tools used by chip designers to insert scan cells for selected signals into the HDL design files comprising a microprocessor design. Currently, these scan insertion tools require HDL design files to be run through a preprocessing program similar to a C language preprocessor that handles compile time variable processing and expansion of HDL macro constructs prior to the scan insertion process. In addition to complexity and performance limitations, one of the significant disadvantages of current scan insertion tools is that the resulting scan inserted HDL design files look very different from the chip designer's original design files due to the wholesale changes made by the preprocessor. Having design files that look so “foreign” to the designer makes verification and debugging of the designs much more difficult.

DFT insertion, such as insertion of scan cells, into HDL can be performed in different ways by the standard software tools. Some tools highlight the HDL segment that needs to be modified and use smart editors that understand HDL and the DFT context. Although such tools exist in the industry, this method still requires significant effort whenever DFT requirements change. Other tools preprocess the HDL and insert DFT into the preprocessed HDL. Although this method makes the insertion a simpler problem, the resulting HDL does not look similar to the original HDL design making it hard to debug.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1 is a block diagram of a typical computer system upon which one embodiment of the present invention may be implemented;

FIG. 2 is a block diagram of a high level architectural view of selective expansion of IHDL macros according to one embodiment of the present invention;

FIG. 3 is a flowchart of tokenizer module processing according to one embodiment of the present invention;

FIG. 4 is a flowchart of “as if” parser processing according to one embodiment of the present invention;

FIG. 5 is a block diagram of a token object according to one embodiment of the present invention;

FIG. 6 is a block diagram illustrating an example of the use of multifaceted tokens according to one embodiment of the present invention;

FIG. 7 is a block diagram illustrating results of tokenization as seen by an as if parser and an output module according to one embodiment of the present invention; and

FIG. 8 is a flow diagram illustrating file output module processing according to one embodiment of the present invention.

### DETAILED DESCRIPTION OF THE INVENTION

A method and apparatus are described for selective expansion of HDL macros for automated design modification. According to one embodiment of the present invention, the selective expansion of HDL macros allows for insertion of scan cells for selected signals into HDL design files representing a hardware design, such as the design of a microprocessor, while making the modified file look as much as possible like the chip designer's original HDL file by using an “as if” approach to parsing HDL design macros, multifaceted parser tokens, and a three-tiered token list. In order to make the modified file look as much as possible like the chip designer's original HDL file, all text except the required changes are preserved from the original file. To accomplish this, the parsing program used by the HDL scan insertion tool creates lists of tokens that record everything including spaces, tabs, and comments. Then to perform the modifications to the HDL, the token lists, representing “lines” from the HDL file, are modified before they are written back out as the updated scan inserted HDL file.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Importantly, while embodiments of the present invention will be described with reference to HDL, scan macros, and integrated circuit design tools, the method and apparatus described herein are thought to be equally applicable to other types of source code compilers and/or preprocessors.

Before describing selective expansion of HDL macros for automated design modification according to various embodiments of the present invention, some terms that will be used throughout this application will briefly be defined.

“As if parsing” generally refers to a process wherein characters within input data are separated in a manner that allows the output of the process to appear that any macros present in the input data have been expanded.

“HDL” stands for Hardware Description Language and means a language, including but not limited to Verilog, VHDL, or other high-level programming languages such as C, C++, etc., that can be used to design integrated circuits.

A “line” consists of one or more ASCII characters followed by a carriage return or other end-of-line symbol.

A “macro” is a name representing a series of commands or functions.

“Macro expansion” generally refers to the process of replacing a macro name with the series of commands or functions that the name represents.

“Scan insertion” generally refers to the process of adding observation points or “scan cells” to a hardware design representation. Typically, scan insertion takes place in a schematic representation. However, according to embodiments of the present invention, scan insertion may involve modification of an HDL file.

A “scan macro” is a name representing a series of scan commands.

A “token” is a single element of a line of data such as a keyword, operator, or punctuation mark.

According to one embodiment of the present invention, in order to make the modified file look as much as possible like the chip designer's original HDL file, all text except the required changes are preserved from the original file. To accomplish this, the parsing program used by the HDL scan insertion tool creates lists of tokens that record everything including spaces, tabs, and comments. Then to perform the modifications to the HDL, the token lists representing “lines” from the HDL file are modified, before they are written back out as the updated scan inserted HDL file.

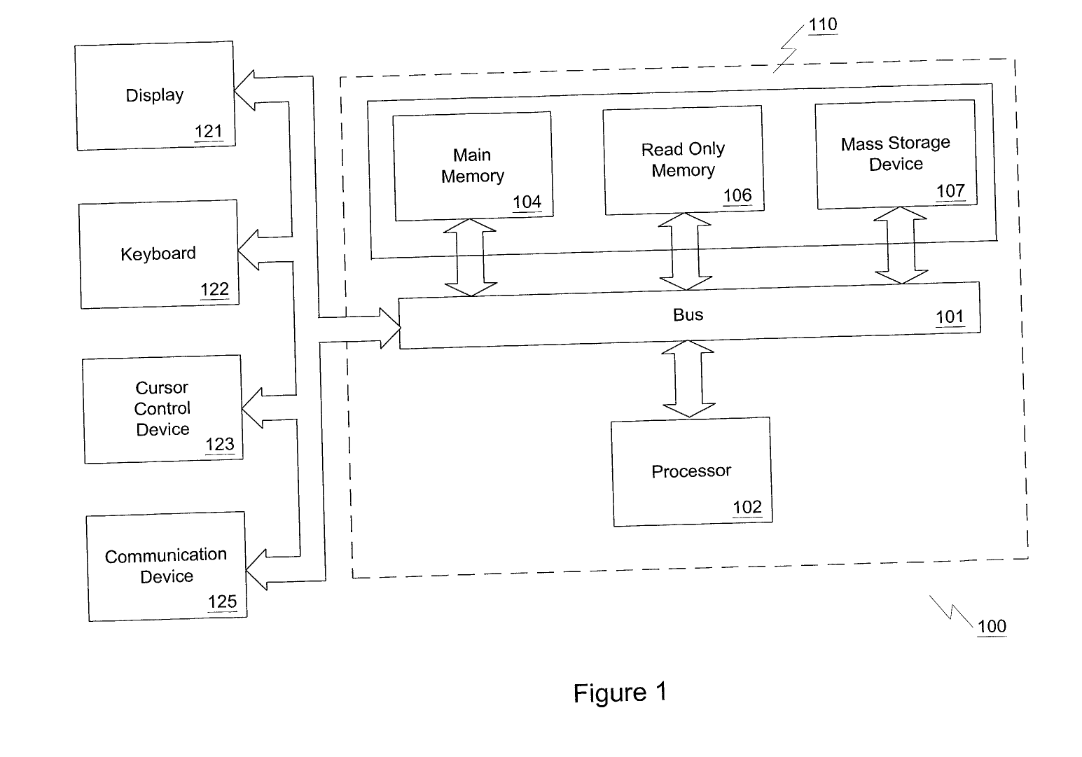

FIG. 1 is a block diagram of a typical computer system upon which one embodiment of the present invention may be implemented. In this example, computer system 100 comprises a bus or other communication means 101 for communicating information, and a processing means such as processor 102 coupled with bus 101 for processing information. Computer system 100 further comprises a random access memory (RAM) or other dynamic storage device 104 (referred to as main memory), coupled to bus 101 for storing information and instructions to be executed by processor 102. Main memory 104 also may be used for storing temporary variables or other intermediate information during execution of instructions by processor 102. Computer system 100 also comprises a read only memory (ROM) and/or other static storage device 106 coupled to bus 101 for storing static information and instructions for processor 102.

A data storage device 107 such as a magnetic disk or optical disc and its corresponding drive may also be coupled to computer system 100 for storing information and instructions. Computer system 100 can also be coupled via bus 101 to a display device 121, such as a cathode ray tube (CRT) or Liquid Crystal Display (LCD), for displaying information to an end user. Typically, an alphanumeric input device 122, including alphanumeric and other keys, may be coupled to bus 101 for communicating information and/or command selections to processor 102. Another type of user input device is cursor control 123, such as a mouse, a trackball, or cursor direction keys for communicating direction information and command selections to processor 102 and for controlling cursor movement on display 121.

A communication device 125 is also coupled to bus 101. The communication device 125 may include a modem, a network interface card, or other well-known interface devices, such as those used for coupling to Ethernet, token ring, or other types of physical attachment for purposes of providing a communication link to support a local or wide area network, for example. In this manner, the computer system 100 may be coupled to a number of clients and/or servers via a conventional network infrastructure, such as a company's Intranet and/or the Internet, for example.

It is appreciated that a lesser or more equipped computer system than the example described above may be desirable for certain implementations. Therefore, the configuration of computer system 100 will vary from implementation to implementation depending upon numerous factors, such as price constraints, performance requirements, technological improvements, and/or other circumstances.

It should be noted that, while the steps described herein may be performed under the control of a programmed processor, such as processor 102, in alternative embodiments, the steps may be fully or partially implemented by any programmable or hardcoded logic, such as Field Programmable Gate Arrays (FPGAs), TTL logic, or Application Specific Integrated Circuits (ASICs), for example. Additionally, the method of the present invention may be performed by any combination of programmed general purpose computer components and/or custom hardware components. Therefore, nothing disclosed herein should be construed as limiting the present invention to a particular embodiment wherein the recited steps are performed by a specific combination of hardware components.

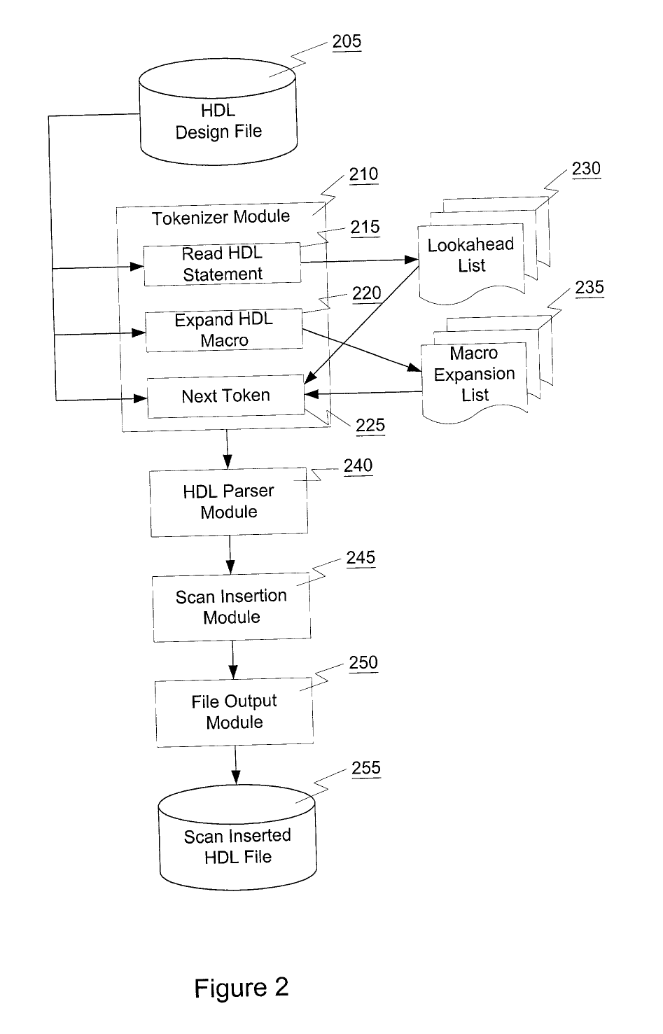

FIG. 2 is a block diagram of a high level architectural view of selective expansion of HDL macros according to one embodiment of the present invention. In this example, a scan insertion tool includes a tokenizer module 110, an HDL parser module 140, a scan insertion module 145, and a file output module 150. The tokenizer module includes a module for reading HDL statements 215, a module for expanding HDL macros 220, and a module for selectively reading tokens 225.

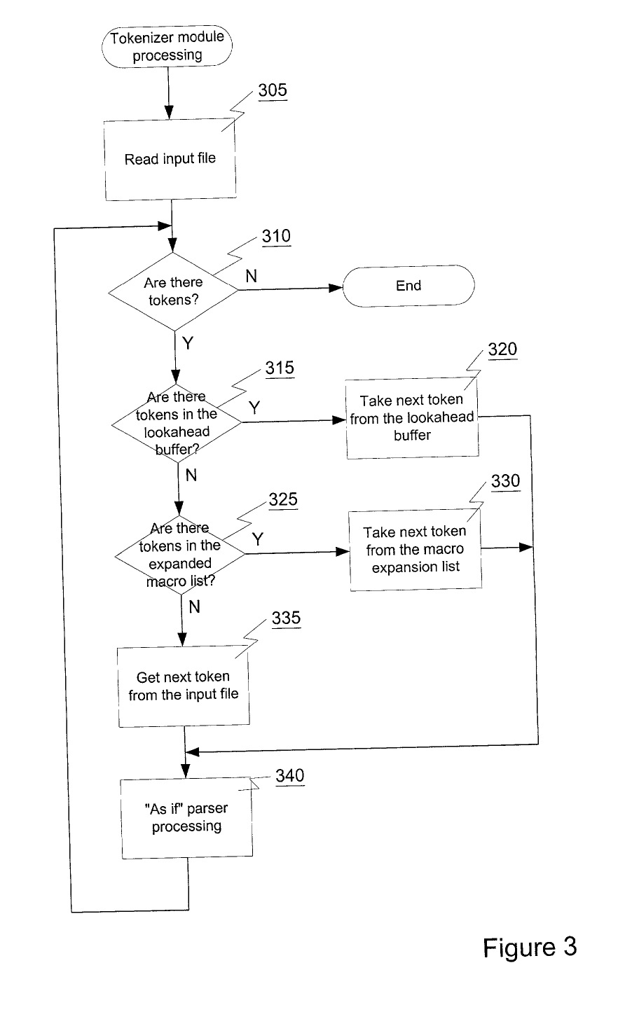

Initially, an HDL file 205 is read by the tokenizer module 210. Briefly, the tokenizer module 210 reads an HDL line 215 from the HDL file 205 and stores lines as necessary in a lookahead list 230. This lookahead list is used to temporarily store lines as necessary. For example, several lines may need to be stored when a single HDL statement consists of more than one line of code. The tokenizer module 210 recursively expands HDL macros 220 and stores the expanded macros in a macro expansion list 235. As necessary, the tokenizer module 210 reads 225 tokens first from the lookahead list 230, then from the macro expansion list 235, and finally from the HDL file 205 and passes them to the HDL parser module 240. The processing of the tokenizer module 210 will be discussed in greater detail below with reference to FIG. 3.

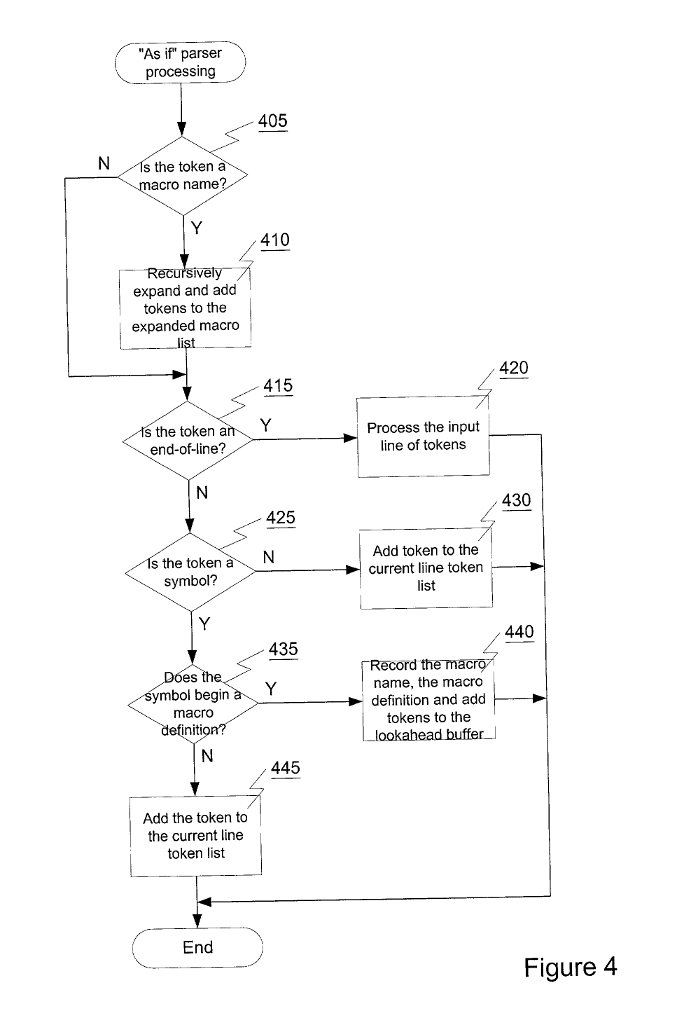

The HDL parser module 240 is presented with a stream of tokens from the tokenizer module “as if” all the macros have been expanded. This allows the parsing to be separated from the problem of selective macro expansion. The parsing program therefore sees only the expanded macros. The “as if” parsing process is discussed in greater detail below with reference to FIG. 4.

After the “as if” parsing process, the HDL parser module 240 then passes the parsed tokens to the scan insertion module 245 that inserts the scan commands. The file output module 250 is presented with a stream of tokens as if the scan macros have been expanded and non-scan related macros have not been expanded. Consequently, as will be described further below, the file output module 250 and the HDL parser module 240 may have different perspectives of the token stream, thereby providing an appropriate view of the token stream based on the context of its usage. The file output module 250 then writes the scan inserted HDL into a file 255. Using this method of scan insertion employing context sensitive macro expansion, a software tool can insert scan commands into an HDL design file in a way that preserves the text of the original file.

FIG. 3 is a flowchart of tokenizer module processing according to one embodiment of the present invention. As mentioned above, the tokenizer module 210 first reads a line from the input file at processing block 305. If tokens are found in the input file at decision block 310, a determination is made in decision blocks 315 and 325 regarding from where the next token should be read. If at decision block 315 tokens are found in the lookahead buffer, the next token will be read from this buffer at processing block 320. Otherwise, if at decision block 325 tokens are found in the expanded macro list, the next token will be read from this list at processing block 330. If no tokens are found in the lookahead buffer or the expanded macro list at decision blocks 315 and 325 respectively, the next token will be taken from the input file at processing block 335. The next token is then passed to the “as if” parser processing at processing block 340.

FIG. 4 is a flowchart of “as if” parser processing according to one embodiment of the present invention. Initially, a determination is made at decision block 405 whether the token is a macro name. If the token is a macro name, the token is recursively expanded and added to the expanded macro list at processing block 410. As explained above, the tokenizer module 210 created multifaceted tokens that cause the parser module 240 to see an expanded token stream representing scan related macros and cause non-scan related expansions to be transparent to the file output module 250.

Further decisions are made at decision blocks 415, 425 and 435 based on the type of token found. If the token is found to be an end-of-line character at decision block 415, the input line of tokens is processed at processing block 420. If the token is found to be anything other than a symbol at decision block 425, the token is added to the current line token list at processing block 430. If the token is a symbol and at decision block 435 is determined to be a symbol that begins a macro definition, the macro name and definition are recorded and the token is added to the lookahead buffer at processing block 440. If the symbol does not begin a macro definition, the token is added to the current line token list at processing block 445.

By using a tokenizing module in conjunction with an “as if” parser as described above, the lower level complexity is separated from the parsing. The HDL parsing program is presented with a stream of tokens by the tokenizing module “as if” all the macros have been expanded. This allows the parsing to be separated from the problem of selective macro expansion. The parsing program sees only the expanded macros.

According to one embodiment of the present invention, to accomplish separating tokenizing and parsing, the HDL parser tokens are made multifaceted. That is, they could appear differently to different parts of the program. To accomplish this, additional fields are added to the parser token objects to contain the various views that different parts of the program see. With this data structure, the HDL parser can see the view of the token stream that show the expanded macros. However, the HDL output module can see a view of the token stream that limits expanded macros to those that involve scan related changes thereby presenting a view of the scan inserted HDL file that looks similar to the original HDL design file.

This multi view approach allows for fully expanding the HDL macros, but only writing out the portions that involve scan related changes thus preserving as much as possible the appearance of the original HDL design file. Tokens can also be “hidden” from the HDL parser by turning them into white space for the HDL parser. These hidden tokens are still present in the token stream, only hidden from the HDL parser. Therefore, if a macro requires no scan related changes and does not need to be expanded, the original macro is preserved and is available to be written out.

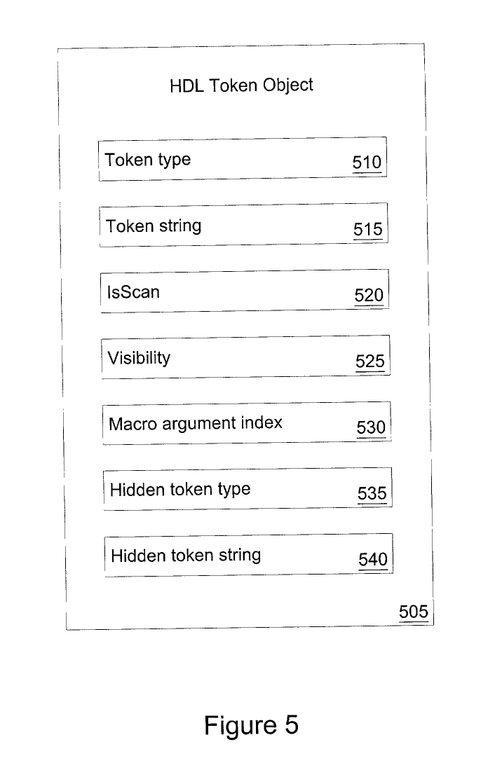

FIG. 5 is a block diagram of a token object according to one embodiment of the present invention. This token object 505 includes a token type 510, a token string 515, an “IsScan” variable 520, a visibility variable 525, a macro argument index 530, a hidden token type 535, and a hidden token string 540. In this example, the token type 510 can be symbol, whitespace, operator, or quote among others. The token string 515 is the actual text of the token. The “isScan” variable 520 represents whether this token is related to scan insertion. The visibility variable 525 represents which parts of the program may view the token such as the parser, the output module, or others. The macro argument index 530 is used for expanding HDL macros.

The hidden token type 535 is the type hidden from the parser. The hidden token string 440 is the text of the token hidden from the parser.

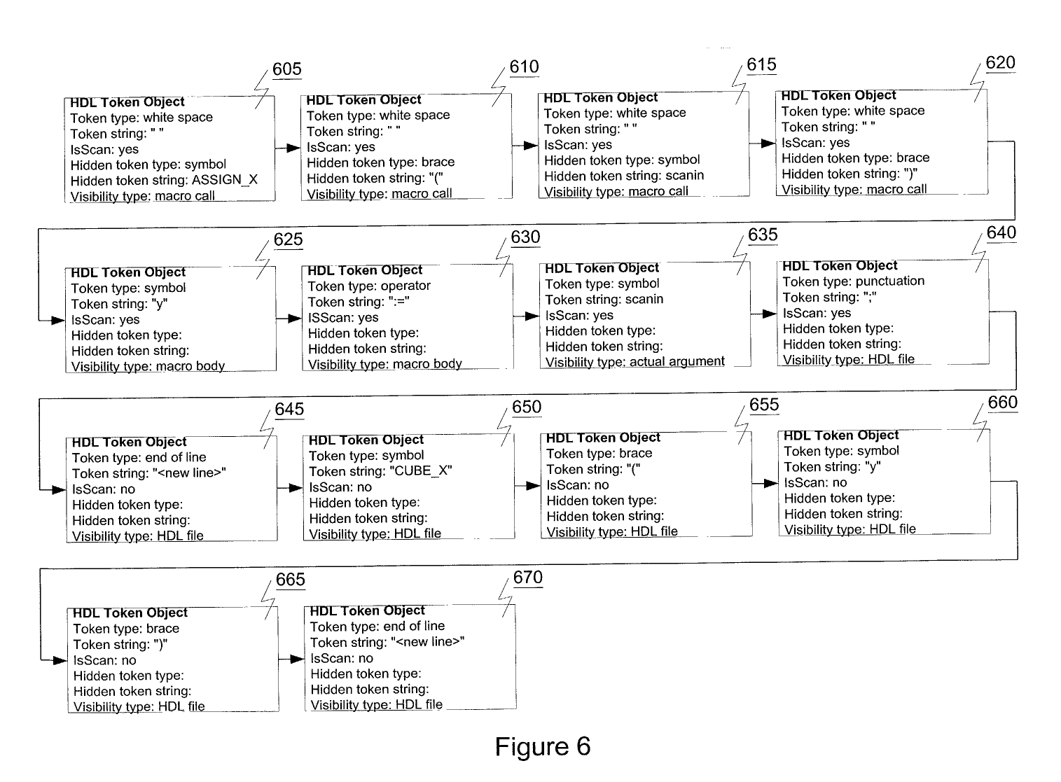

FIG. 6 is a block diagram illustrating an example of the use of multifaceted tokens according to one embodiment of the present invention. In this example, assume that an HDL file contains the macro definition statement DEFINE ASSIGN_X(x)=[y:=x]. The HDL statement ASSIGN_X(scanin) would be parsed and produce a token list as illustrated in FIG. 6. First, the ASSIGN_X would be recognized as a macro call 605 since the DEFINE statement would place it in a symbol table. The macro call tokens “(“, “scanin”, and”)” would be added to a macro call token list 610-620. The macro call would be expanded to the token list “y”, “:=”, and “scanin” 625-635 with the “x” formal argument replaced by the “scanin” actual argument 635.

Notice that the macro call is still present in the first four tokens 605-620 but has been turned into white space as far as the parser is concerned. That is, the parser does not see the hidden token strings. The parser sees the expanded form of the macro call and will process those tokens 625-645. If the expanded macro involves scan, then the expanded macro tokens 625-645 will be used to write the updated line to the HDL file. If the expanded macro does not involve scan, then the original macro call 605-620 and 640-645 will be written to the HDL file thereby preserving the original HDL line.

Additionally, for the sake of example, assume that the HDL file contained the definition statement DEFINE CUBE_X(x)=[x*x*x]. The HDL statement ycubed :=CUBE_X(y); would be parsed and produce a token list as indicated in blocks 650-670. Since the macro does not relate to scan insertion, there are no hidden tokens and the macro is not expanded.

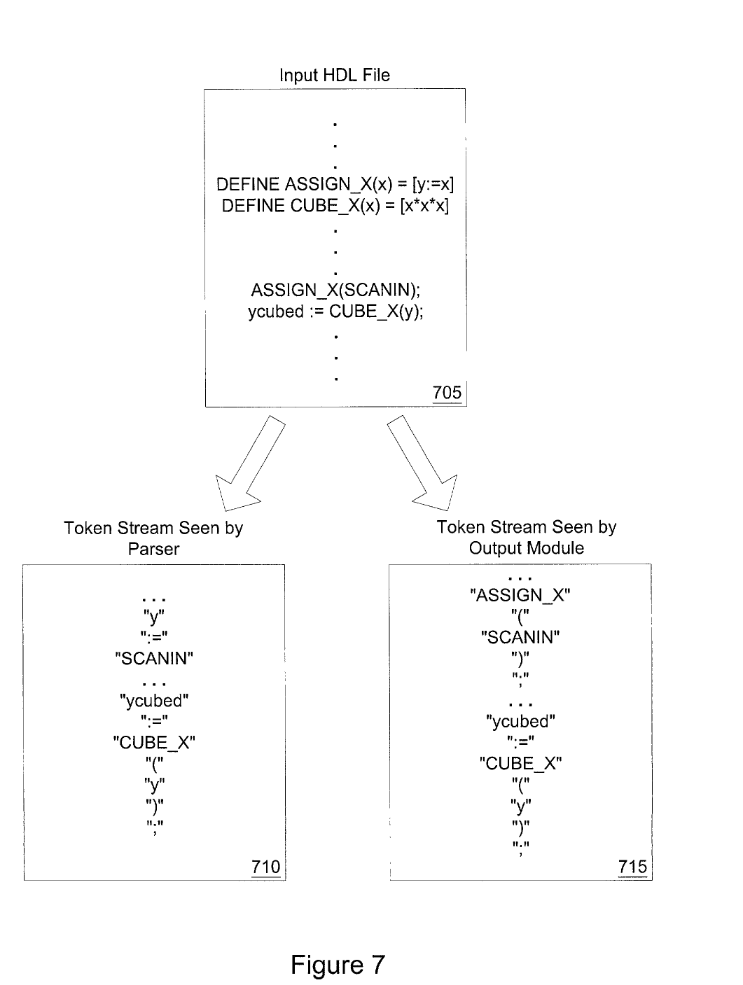

FIG. 7 is a block diagram illustrating results of tokenization as seen by an as if parser and an output module according to one embodiment of the present invention. In this example, an input file 705 contains the definition statements DEFINE ASSIGN_X(x)=[y:=x] and DEFINE CUBE_X(x)=[x*x*x]. Later in the input file 705 the statements ASSIGN_X(SCANIN); and ycubed :=CUBE_X(y); are found. That is, the statement relating the ASSIGN_X macro is scan related, the statement relating to the CUBE_X macro is not scan related. As a result, the parser will see a token stream 710 containing the expanded form of the ASSIGN_X macro and an unexpanded form of the CUBE_X macro. The output module will see a token stream 715 containing unexpanded forms of both macros.

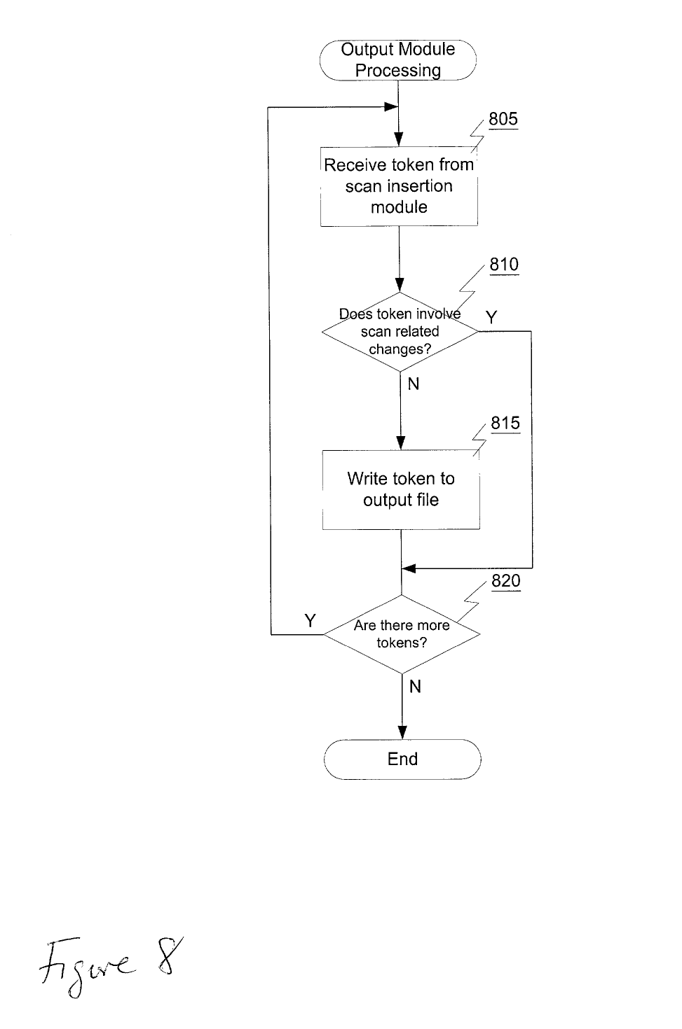

FIG. 8 is a flow diagram illustrating file output module processing according to one embodiment of the present invention. In this example, a token is received from the scan insertion module at processing block 805. At decision block 810, a determination is made whether the token involves scan related changes. If the token is not scan related it is written to the output file at processing block 815. If the token is scan related processing jumps to block 820. At processing block 820, a determination is made whether more tokens are to be received from the scan insertion module. Processing continues in this manner until no tokens remain.

APPENDIX A
William E. Alford, Reg. No. 37,764; Farzad E. Amini, Reg. No. 42,261; William Thomas Babbitt, Reg. No.
39,591; Carol F. Barry, Reg. No. 41,600; Jordan Michael Becker, Reg. No. 39,602; Lisa N. Benado, Reg.
No. 39,995; Bradley J. Bereznak, Reg. No. 33,474; Michael A. Bernadicou, Reg. No. 35,934; Roger W.
Blakely, Jr., Reg. No. 25,831; R. Alan Burnett, Reg. No. 46,149; Gregory D. Caldwell, Reg. No. 39,926;
Andrew C. Chen, Reg. No. 43,544; Thomas M. Coester, Reg. No. 39,637; Donna Jo Coningsby, Reg. No.
41,684; Florin Corie, Reg. No. 46,244; Dennis M. deGuzman, Reg. No. 41,702; Stephen M. De Klerk,
Reg. No. 46,503; Michael Anthony DeSanctis, Reg. No. 39,957; Daniel M. De Vos, Reg. No. 37,813;
Justin Dillon, Reg. No. 42,486; Sanjeet Dutta, Reg. No. 46,145; Matthew C. Fagan, Reg. No. 37,542;
Tarek N. Fahmi, Reg. No. 41,402; George Fountain, Reg. No. 37,374; James Y. Go, Reg. No. 40,621;
James A. Henry, Reg. No. 41,064; Libby N. Ho, Reg. No. 46,774; Willmore F. Holbrow III, Reg. No.
41,845; Sheryl Sue Holloway, Reg. No. 37,850; George W Hoover II, Reg. No. 32,992; Eric S. Hyman,
Reg. No. 30,139; William W. Kidd, Reg. No. 31,772; Sang Hui Kim, Reg. No. 40,450; Walter T. Kim, Reg.
No. 42,731; Eric T. King, Reg. No. 44,188; George Brian Leavell, Reg. No. 45,436; Kurt P. Leyendecker,
Reg. No. 42,799; Gordon R. Lindeen III, Reg. No. 33,192; Jan Carol Little, Reg. No. 41,181; Robert G.
Litts, Reg. No. 46,876; Joseph Lutz, Reg. No. 43,765; Michael J. Mallie, Reg. No. 36,591; Andre L.
Marais, under 37 C.F.R. § 10.9(b); Paul A. Mendonsa, Reg. No. 42,879; Clive D. Menezes, Reg. No.
45,493; Chun M. Ng, Reg. No. 36,878; Thien T. Nguyen, Reg. No. 43,835; Thinh V. Nguyen, Reg. No.
42,034; Dennis A. Nicholls, Reg. No. 42,036; Robert B. O'Rourke, Reg. No. 46,972; Daniel E. Ovanezian,
Reg. No. 41,236; Kenneth B. Paley, Reg. No. 38,989; Gregg A. Peacock, Reg. No. 45,001; Marina
Portnova, Reg. No. 45,750; William F. Ryann, Reg. 44,313; James H. Salter, Reg. No. 35,668; William W.
Schaal, Reg. No. 39,018; James C. Scheller, Reg. No. 31,195; Jeffrey C. Schubert, Reg. No. 43,098;
George Simion, Reg. No. 47,089; Jeffrey Sam Smith, Reg. No. 39,377; Maria McCormack Sobrino, Reg.
No. 31,639; Stanley W. Sokoloff, Reg. No. 25,128; Judith A. Szepesi, Reg. No. 39,393; Vincent P.
Tassinari, Reg. No. 42,179; Edwin H. Taylor, Reg. No. 25,129; John F. Travis, Reg. No. 43,203; Joseph
A. Twarowski, Reg. No. 42,191; Mark C. Van Ness, Reg. No. 39,865; Tom Van Zandt, Reg. No. 43,219;
Brent E. Vecchia, Reg. No. 48,011; Lester J. Vincent, Reg. No. 31,460; Glenn E. Von Tersch, Reg. No.
41,364; John Patrick Ward, Reg. No. 40,216; Mark L. Watson, Reg. No. 46,322; Thomas C. Webster,
Reg. No. 46,154; and Norman Zafman, Reg. No. 26,250; my patent attorneys, and Firasat Ali, Reg. No.
45,715; Justin M. Dillon, Reg. No. 42,486; Thomas S. Ferrill, Reg. No. 42,532; and Raul Martinez, Reg.
No. 46,904, my patent agents, of BLAKELY, SOKOLOFF, TAYLOR & ZAFMAN LLP, with offices located
at 12400 Wilshire Boulevard, 7th Floor, Los Angeles, California 90025, telephone (310) 207-3800, and
Alan K. Aldous, Reg. No. 31,905; Edward R. Brake, Reg. No. 37,784; Ben Burge, Reg. No. 42,372; Paul
W. Churilla, Reg. No. P47,495; Jeffrey S. Draeger, Reg. No. 41,000; Cynthia Thomas Faatz, Reg No.
39,973; John N. Greaves, Reg. No. 40,362; Seth Z. Kalson, Reg. No. 40,670; David J. Kaplan, Reg. No.
41,105; Peter Lam, Reg. No. 44,855; Charles A. Mirho, Reg. No. 41,199; Michael J. Nesheiwat, Patent
Agent, Reg. No. P47,819; Leo V. Novakoski, Reg. No. 37,198; Thomas C. Reynolds, Reg. No. 32,488;
Kenneth M. Seddon, Reg. No. 43,105; Mark Seeley, Reg. No. 32,299; Steven P. Skabrat, Reg. No.
36,279; Howard A. Skaist, Reg. No. 36,008; Gene I. Su, Reg. No. 45,140; Calvin E. Wells, Reg. No.
P43,256, Raymond J. Werner, Reg. No. 34,752; Robert G. Winkle, Reg. No. 37,474; Steven D. Yates,
Reg. No. 42,242; and Charles K. Young, Reg. No. 39,435; my patent attorneys, of INTEL
CORPORATION; and James R. Thein, Reg. No. 31,710, my patent attorney with full power of
substitution and revocation, to prosecute this application and to transact all business in the
Patent and Trademark Office connected herewith.

APPENDIX B
Title 37, Code of Federal Regulations, Section 1.56
Duty to Disclose Information Material to Patentability

(a) A patent by its very nature is affected with a public interest. The public interest is best served,

and the most effective patent examination occurs when, at the time an application is being examined, the
Office is aware of and evaluates the teachings of all information material to patentability. Each individual
associated with the filing and prosecution of a patent application has a duty of candor and good faith in
dealing with the Office, which includes a duty to disclose to the Office all information known to that individual
to be material to patentability as defined in this section. The duty to disclosure information exists with respect
to each pending claim until the claim is cancelled or withdrawn from consideration, or the application becomes
abandoned. Information material to the patentability of a claim that is cancelled or withdrawn from
consideration need not be submitted if the information is not material to the patentability of any claim
remaining under consideration in the application. There is no duty to submit information which is not material
to the patentability of any existing claim. The duty to disclosure all information known to be material to
patentability is deemed to be satisfied if all information known to be material to patentability of any claim
issued in a patent was cited by the Office or submitted to the Office in the manner prescribed by §§ 1.97(b)-(d)
and 1.98. However, no patent will be granted on an application in connection with which fraud on the Office
was practiced or attempted or the duty of disclosure was violated through bad faith or intentional misconduct.
The Office encourages applicants to carefully examine:

| | |
|---|---|
| (1) | Prior art cited in search reports of a foreign patent office in a counterpart application, and |
| (2) | The closest information over which individuals associated with the filing or prosecution of a |

patent application believe any pending claim patentably defines, to make sure that any material information
contained therein is disclosed to the Office.

| | |
|---|---|
| (b) | Under this section, information is material to patentability when it is not cumulative to |

information already of record or being made or record in the application, and

| | |
|---|---|
| (1) | It establishes, by itself or in combination with other information, a prima facie case of |

unpatentability of a claim; or

| | |
|---|---|
| (2) | It refutes, or is inconsistent with, a position the applicant takes in: |
| (i) | Opposing an argument of unpatentability relied on by the Office, or |
| (ii) | Asserting an argument of patentability. |

A prima facie case of unpatentability is established when the information compels a conclusion that a claim is
unpatentable under the preponderance of evidence, burden-of-proof standard, giving each term in the claim
its broadest reasonable construction consistent with the specification, and before any consideration is given to
evidence which may be submitted in an attempt to establish a contrary conclusion of patentability.

| | |
|---|---|
| (c) | Individuals associated with the filing or prosecution of a patent application within the |

meaning of this section are:

| | |
|---|---|
| (1) | Each inventor named in the application; |
| (2) | Each attorney or agent who prepares or prosecutes the application; and |
| (3) | Every other person who is substantively involved in the preparation or prosecution of the |

application and who is associated with the inventor, with the assignee or with anyone to whom there is an
obligation to assign the application.

| | |
|---|---|
| (d) | Individuals other than the attorney, agent or inventor may comply with this section by |

disclosing information to the attorney, agent, or inventor.

What is claimed is:

1. A method comprising:
reading a line of data from a file containing source code written in a high level language;
generating a stream of tokens from said line of data, said stream of tokens representing any of a specific type of macro in said line of data as being expanded while other types of macros are not expanded;
parsing said stream of tokens;
inserting commands representing operations to be performed by a macro into said stream of tokens if a macro is present; and
writing said stream of token to an output file.

2. The method of claim 1, wherein said generating a stream of tokens further comprises:
determining whether tokens are present in either an input file, a lookahead buffer, or a macro expansion list; and
responsive to finding tokens, reading said tokens first from said lookahead buffer, then from said macro expansion list, then from said input file;
presenting said tokens to a parser so that any macro in said line of data appears to have been expanded.

3. The method of claim 1, wherein said parsing further comprises:
determining a type of token read;
responsive to determining that the token is an end-of-line, processing an input line of tokens;
responsive to determining that the token is not a symbol, adding the token to a current line token list;
responsive to determining that the token is a symbol that indicates a beginning of a macro definition, recording the macro name and macro definition and adding the tokens to a lookahead buffer; and
responsive to determining that the token is a symbol that does not indicate a beginning of a macro definition, adding the token to a current line token list.

4. The method of claim 1, wherein said writing comprises:
writing expanded macro tokens to said output file if said macro is of said specific type of macro; and
writing an original macro call to said output file if said macro is not said specific type of macro.

5. The method of claim 1, wherein said source code written in a high level language comprises a hardware description language (HDL) for representing hardware designs.

6. The method of claim 1, wherein said specific type of macro comprises a scan macro.

7. A method of scan insertion comprising:
reading a hardware description language (HDL) representation of a hardware design, the HDL including a plurality of macro definitions some of which relate to scan insertion;
creating a token stream based on the HDL representation that includes multifaceted tokens that can be hidden from or made visible to a subsequent parsing process by expanding the plurality of macro definitions and making tokens associated with scan macros visible to the subsequent parsing process and marking other tokens as hidden;
performing scan insertion by parsing those of the multifaceted tokens that are visible to the parser and adding appropriate scan commands; and
generating a scan inserted HDL file containing expanded versions of the macro definitions which relate to scan insertion but that omits expanded versions of those that do not relate to scan insertion.

8. The method of claim 7, wherein said HDL comprises a high-level language.

9. The method of claim 7, wherein said hardware design represents an integrated circuit design.

10. A system comprising:
a storage device having stored therein one or more routines for selectively expanding macros within source code; and
a processor coupled to the storage device for executing the one or more routines for selectively expanding macros within source code which, when executing said routine:
reads a line of data from a file containing source code written in a high level language;
generates a stream of tokens from said line of, said stream of tokens representing any of a specific type of macro in said line of data as being expanded while other types of macros are not expanded;
parses said stream of tokens;
inserts commands representing operations to be performed by a macro into said stream of tokens if a macro is present; and
writes said stream of token to an output file.

11. The system of claim 10, wherein said generating a stream of tokens further comprises:
determining whether tokens are present in either an input file, a lookahead buffer, or a macro expansion list; and
responsive to finding tokens, reading said tokens first from said lookahead buffer, then from said macro expansion list, then from said input file;
presenting said tokens to a parser so that any macro in said line of data appears to have been expanded.

12. The system of claim 10, wherein said parsing further comprises:
determining a type of token read;
responsive to determining that the token is an end-of-line, processing an input line of tokens;
responsive to determining that the token is not a symbol, adding the token to a current line token list;
responsive to determining that the token is a symbol that indicates a beginning of a macro definition, recording the macro name and macro definition and adding the tokens to a lookahead buffer; and
responsive to determining that the token is a symbol that does not indicate a beginning of a macro definition, adding the token to a current line token list.

13. The system of claim 10, wherein said writing comprises:
writing expanded macro tokens to said output file if said macro is of said specific type of macro; and
writing an original macro call to said output file if said macro is not said specific type of macro.

14. The system of claim 10, wherein said source code written in a high level language comprises a hardware description language (HDL) for representing hardware designs.

15. The system of claim 10, wherein said specific type of macro comprises a scan macro.

16. A machine-readable medium having stored thereon data representing sequences of instructions, the sequences of instructions which, when executed by a processor, cause the processor to selectively expand macros by:
reading a line of data from a file containing source code written in a high level language;
generating a stream of tokens from said line of, said stream of tokens representing any of a specific type of macro in said line of data as being expanded while other types of macros are not expanded;
parsing said stream of tokens;
inserting commands representing operations to be performed by a macro into said stream of tokens if a macro is present; and
writing said stream of token to an output file.

17. The machine-readable medium of claim 16, wherein said generating a stream of tokens further comprises:
determining whether tokens are present in either an input file, a lookahead buffer, or a macro expansion list; and
responsive to finding tokens, reading said tokens first from said lookahead buffer, then from said macro expansion list, then from said input file;
presenting said tokens to a parser so that any macro in said line of data appears to have been expanded.

18. The machine-readable medium of claim 16, wherein said parsing further comprises:
determining a type of token read;
responsive to determining that the token is an end-of-line, processing an input line of tokens;
responsive to determining that the token is not a symbol, adding the token to a current line token list;
responsive to determining that the token is a symbol that indicates a beginning of a macro definition, recording the macro name and macro definition and adding the tokens to a lookahead buffer; and
responsive to determining that the token is a symbol that does not indicate a beginning of a macro definition, adding the token to a current line token list.

19. The machine-readable medium of claim 16, wherein said writing comprises:
writing expanded macro tokens to said output file if said macro is of said specific type of macro; and
writing an original macro call to said output file if said macro is not said specific type of macro.

20. The machine-readable medium of claim 16, wherein said source code written in a high level language comprises a hardware description language (HDL) for representing hardware designs.

21. The machine-readable medium of claim 16, wherein said specific type of macro comprises a scan macro.

22. A machine-readable medium having stored thereon data representing sequences of instructions, the sequences of instructions which, when executed by a processor, cause the processor to perform scan insertion by:
reading a hardware description language (HDL) representation of a hardware design, the HDL including a plurality of macro definitions some of which relate to scan insertion;
creating a token stream based on the HDL representation that includes multifaceted tokens that can be hidden from or made visible to a subsequent parsing process by expanding the plurality of macro definitions and making tokens associated with scan macros visible to the subsequent parsing process and marking other tokens as hidden;
performing scan insertion by parsing those of the multifaceted tokens that are visible to the parser and adding appropriate scan commands; and
generating a scan inserted HDL file containing expanded versions of the macro definitions which relate to scan insertion but that omits expanded versions of those that do not relate to scan insertion.

23. The machine-readable medium of claim 22, wherein said HDL comprises a high-level language.

24. The machine-readable medium of claim 22, wherein said hardware design represents an integrated circuit design.
